(19) United States
(12) Patent Application Publication
(10) Pub. No.: US 2018/0142833 A1
(43) Pub. Date: May 24, 2018

(54) APPARATUS FOR SUPPORTING A PERSONAL ARTICLE ON A STRUCTURE

(71) Applicants: Elliot SASSON, New York, NY (US); Joseph BELVERIO, Bloomfield, NJ (US)

(72) Inventors: Elliot SASSON, New York, NY (US); Joseph BELVERIO, Bloomfield, NJ (US)

(21) Appl. No.: 15/817,625

(22) Filed: Nov. 20, 2017

Related U.S. Application Data
(60) Provisional application No. 62/424,616, filed on Nov. 21, 2016.

(51) Int. Cl. F16M 13/02; F16M 11/04; F16M 11/08; A47G 25/06; A47B 96/06

(52) U.S. Cl. CPC F16M 13/022; F16M 11/046; F16M 11/08; A47G 25/10; A47B 96/067; F16M 2200/028; A47G 25/0614

(57) ABSTRACT

A support apparatus that includes a bracket section with a bracket for support on a structure, a hook section supported by the bracket and an intermediate section connecting the bracket section to the hook section.

### CROSS-REFERENCE TO RELATED APPLICATION

The present application claims priority to U.S. Provisional Application Ser. No. 62/424,616, filed Nov. 21, 2016, the entire disclosure of which is incorporated by reference herein.

### FIELD OF THE INVENTION

The present invention relates to an apparatus for supporting a personal article such a towel, an article of clothing (for example, a coat or a hat), an umbrella or the like personal article on a structure such as a door.

### BACKGROUND OF THE INVENTION

Bracket-supported hooks for supporting a personal article on a structure such as a door are known.

A known bracket-supported hook includes at least one hook part on which a personal article may be supported, a bracket part that supports the at least one hook part on a door, and an intermediate part that connects the hook part and the bracket part.

Another known arrangement includes a plurality of hook parts, a bracket part that supports the hook parts on a door, and an intermediate part that connects the hook parts to the bracket part.

Yet another known arrangement includes a plurality of laterally arranged hook parts, a plurality of bracket parts that support the hook parts on a door, and an intermediate part that connects the hook parts with the plurality of bracket parts.

In these known arrangements, the hook part or the hook parts, the bracket part or the bracket parts, and the intermediate part have fixed dimensions that cannot be adjusted.

Furthermore, the orientation of the at least one hook part, or the orientation of the hook parts, is fixed and cannot be changed relative to the other parts of the arrangement.

### SUMMARY OF THE INVENTION

It is an object of the present invention to provide an apparatus for supporting a personal article such as a towel, an article of clothing, an umbrella, or the like article, on a structure such as a door, a cabinet door, a window frame, and a closet door.

An apparatus according to the present invention includes a bracket section, a hook section supported by the bracket section, and an intermediate section connecting the bracket section to the hook section, at least one of the bracket section and the intermediate section being adjustable.

The hook section in an apparatus according to the present invention may have hooks that can be reoriented relative to one another.

In the preferred embodiment, the intermediate section is adjustable telescopically to permit length adjustment.

In the preferred embodiment, the bracket section includes a bracket portion that can be displaced relative to the intermediate section to permit the fitting of the bracket section to the support structure (e.g. the thickness of the door on which the apparatus is to be mounted).

Other features and advantages of the present invention will become apparent from the following description of the invention which refers to the accompanying drawings.

### BRIEF DESCRIPTION OF THE DRAWING(S)

FIGS. 1A-1F show, respectively, the top view, a perspective view, the right side view, the front view, the left side view, and the bottom view of an embodiment of an apparatus according to the present invention.

FIGS. 2A-2D show, respectively, the top view, a perspective view, the front view, and the left side view of a first elongated body used in the construction of the embodiment depicted in FIGS. 1A-1F.

FIGS. 3A-3D show, respectively, the top view, a perspective view, the front view and the left side view of a second elongated body used in the construction of the embodiment depicted in FIGS. 1A-1F.

FIGS. 4A-4F show, respectively, the top view, a perspective view, the front view, the left side view, the bottom view, and another perspective view of a latch used in the construction of the embodiment depicted in FIGS. 1A-1F.

FIGS. 5A-5D show, respectively, the top view, a perspective view, the front view, and the left side view of a hook support used in the construction of the hook assembly of the embodiment depicted in FIGS. 1A-1F.

FIGS. 6A-6D show, respectively, the top view, a perspective view, the left side view, and the back side view of the top hook in the embodiment depicted in FIGS. 1A-1F.

FIGS. 7A-7D show, respectively, the top view, a perspective view, the left side view, and the back side view of the middle hook in the embodiment depicted in FIGS. 1A-1F.

FIGS. 8A-8D show, respectively, the top view, a perspective view, the left side view, and the back side view of the bottom hook in the embodiment depicted in FIGS. 1A-1F.

FIGS. 9A-9F show, respectively, the top view, a perspective view, the front view, the left side view, the bottom view, and another perspective view of the bottom part of the bracket housing used in the construction of the bracket assembly of the embodiment depicted in FIGS. 1A-1F.

FIGS. 10A-10E show, respectively, the bottom view, a perspective view, the back view, the left side view, and the top view of a bracket used in the construction of the bracket assembly of the embodiment depicted in FIGS. 1A-1F.

FIGS. 11A-11E show, respectively, the top view, a perspective view, the front view, the left side view, and the bottom view of the top part of the bracket housing used in the construction of the bracket assembly of the embodiment depicted in FIGS. 1A-1F.

FIGS. 12A-12D show, respectively, a first perspective view, a second perspective view, a side view, and the bottom view of a screw used in the construction of the bracket assembly of the embodiment depicted in FIGS. 1A-1F that is used to fix the bracket in position.

FIG. 13A shows a perspective front view of a second embodiment of an apparatus according to the present invention.

FIG. 13B shows a side view of a push-button used in an apparatus according to the second embodiment.

FIG. 13C shows a cross-sectional view of the push-button shown in FIG. 13B mounted in a cradle that is received in the second elongated body.

FIG. 13D shows a front perspective view of a cradle used in the second embodiment to mount the push-button shown in FIG. 13B.

FIGS. 14A-14D illustrate another bracket adjustment mechanism used in the second embodiment of the present invention.

FIG. 15 shows a front view of a third embodiment of the present invention.

FIG. 16A shows a side view of the bracket assembly of the third embodiment.

FIG. 16B shows the bracket assembly of the third embodiment mounted over a door.

FIG. 17A shows the bracket assembly of the third embodiment in a disassembled state.

FIG. 17B and FIG. 17C show the bracket of the bracket assembly of the third embodiment in an unlocked state (FIG. 17B) and a locked state (FIG. 17C).

FIG. 17D shows a cross-sectional view (along the broken line in FIG. 17B) of the bracket assembly of the third embodiment in the unlocked state.

FIG. 17E shows a cross-sectional view (along the broken line in FIG. 17C) of the bracket assembly of the third embodiment in the locked state.

FIG. 17F shows a top perspective view of the preferred embodiment of the bracket assembly of the third embodiment.

FIGS. 18A-18D show the locking mechanism of the third embodiment, with FIG. 18C illustrating a locked state and FIG. 18D the unlocked state.

FIGS. 19A-19D show a hook assembly for use with any one of the embodiments.

FIGS. 20A-20C show a front, a side, and a perspective view of an arrangement that uses two of any one of the embodiments with a cross bar.

FIGS. 21A-21C show a front, a side, and a perspective view of another arrangement that uses two of any one of the embodiments with a cross bar and additional hooks.

### DETAILED DESCRIPTION OF EMBODIMENTS OF THE INVENTION

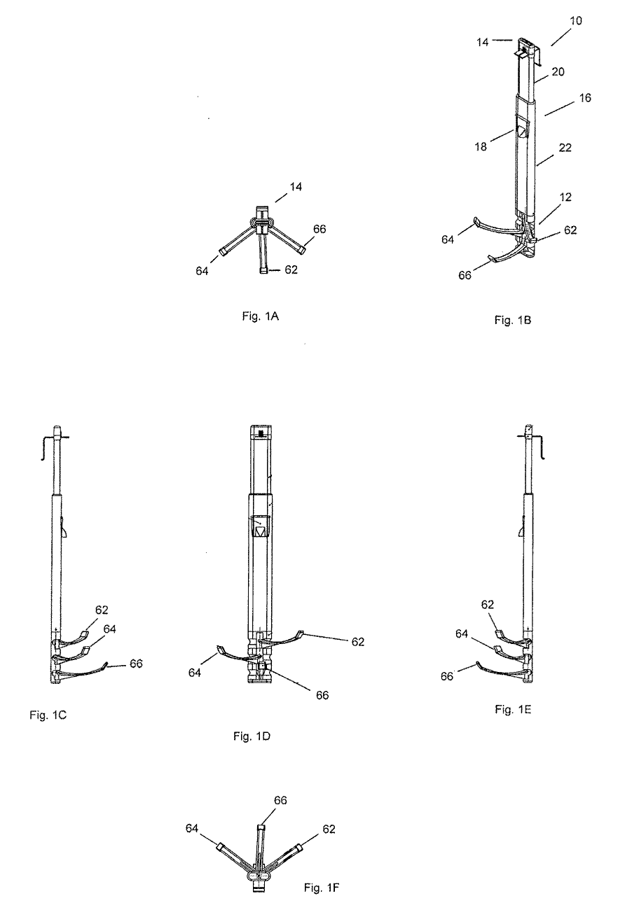

Referring to FIG. 1A-1F, an apparatus 10 according to an embodiment of the present invention includes at least one hook section, which may be realized with a hook assembly 12, and a bracket section to support the hook section, which may be realized with a bracket assembly 14.

According to one aspect of the preset invention, the bracket assembly 14 and the at least one hook assembly 12 are integrated with an intermediate section, which may be realized with a length-adjustable support member, which may be a support arm 16. The support arm 16 may be comprised of at least two elongated bodies 20, 22, for example, two tubes, or a rod and a tube. At least one of the elongated bodies 20, 22 may be displaceable relative to the other elongated body. For example, the elongated bodies may be arranged to be extendible or retractable telescopically to vary the length of the support arm 16.

According to one aspect of the present invention, a locking mechanism 18 can be provided to selectively fix the position of one elongated body relative to the other elongated body in order to permit selectively varying the length of the support arm 16.

The bracket assembly 14 may be integrated with one of the elongated bodies (e.g. body 20) while the hook assembly 12 may be integrated with the other elongated body (e.g. body 22). Thus, the bracket assembly 14 may reside at one end of the length-adjustable support arm 16 and the hook assembly 12 will reside at the other end of the length-adjustable support arm 16. Integration can be realized with any suitable method such as welding, gluing, snap fitting, or fastening with a fastener such as a screw.

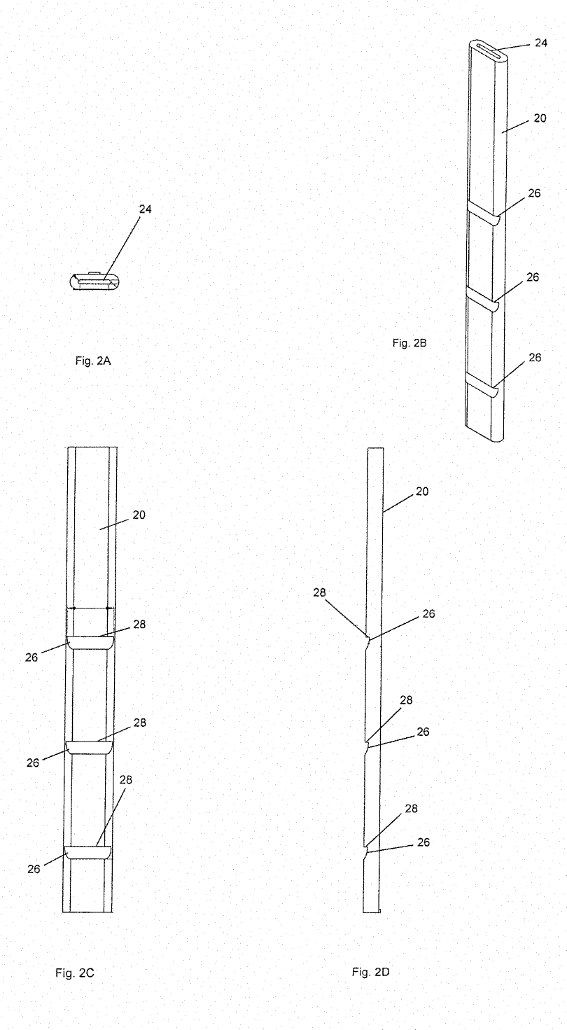

Referring now to FIGS. 2A-2D, the first elongated body 20 may be a tube or a rod. A recess 24 is defined at one end of the first elongated body 20 to receive a tongue portion (described below) of the bracket assembly 14. A plurality of spaced notches 26 (or grooves) are defined on one face of the first elongated body 20. Each notch 26 is defined to have a catch face 28, which is oriented transverse (preferably perpendicular) to the longitudinal axis of the first elongated body 20. Each catch face 28 is located to abut a latch face (described below) of a latch (described below) of the lock mechanism 18.

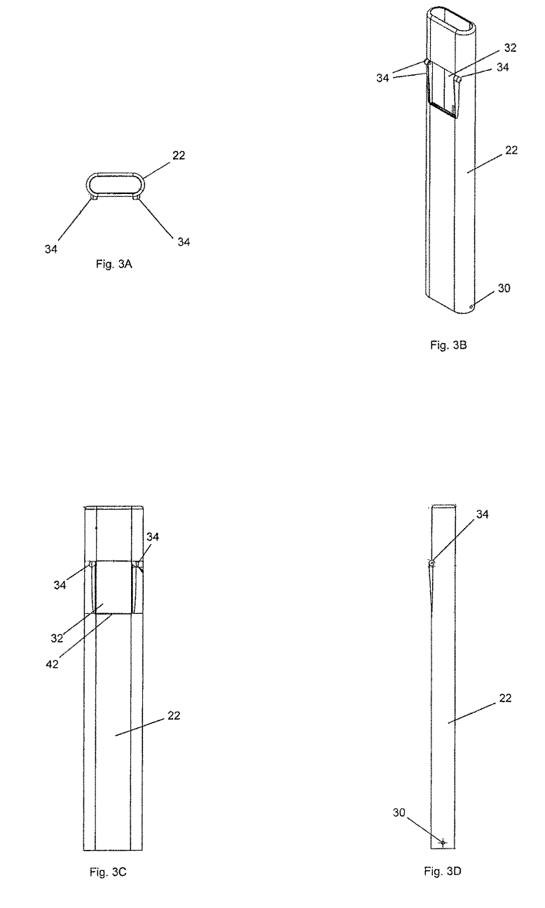

Referring now to FIGS. 3A-3D, the second elongated body 22 may be a tube which is dimensioned to receive the first elongated body 20 therein. The first elongated body 20 is fitted inside the second elongated body in a manner enabling the two elongated bodies 20, 22 to be displaced relative to one another telescopically.

The second elongated body 22 is configured to be coupled to the hook assembly 12 at one end (i.e. bottom end). Thus, for example, an orifice 30 or the like may be defined near the bottom end of the second elongated body 22 to receive a screw or the like to connect the hook assembly 12 to the second elongated body 22.

The first elongated body 20 is received at the other end (top end) of the second elongated body 22. In the preferred embodiment, the first elongated body 20 has an oblong transverse cross-section received in an oblong longitudinal opening in the second elongated body 22. Other shapes could be adopted without deviating from the scope of the present invention.

A window 32 may be defined in one face of the second elongated body 22. Two pivot posts 34 are provided opposite each other at respective lateral sides of the window 32 between the top and the bottom edges of the window 32.

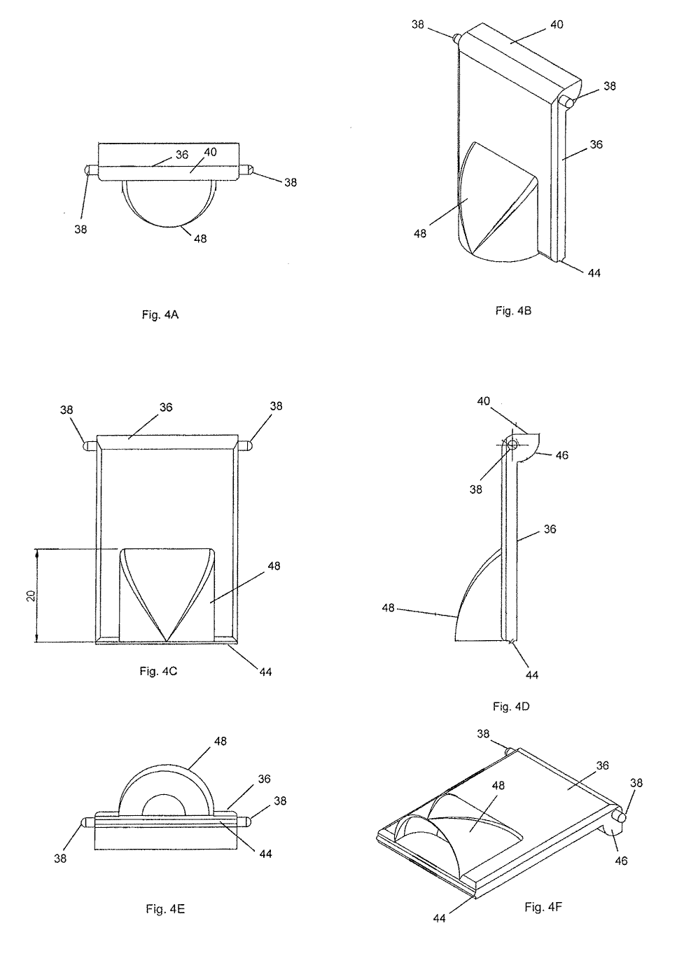

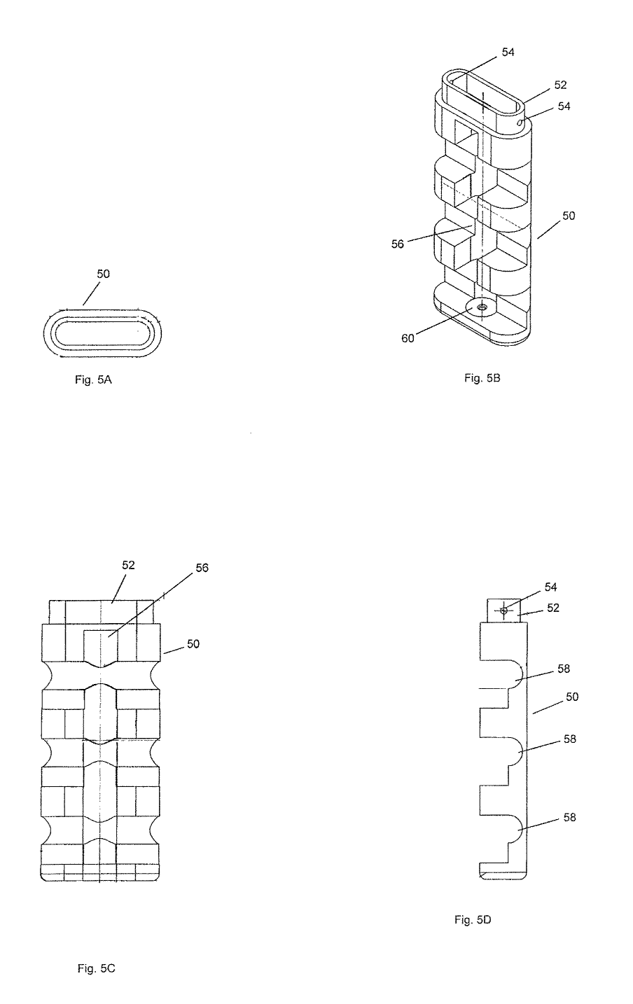

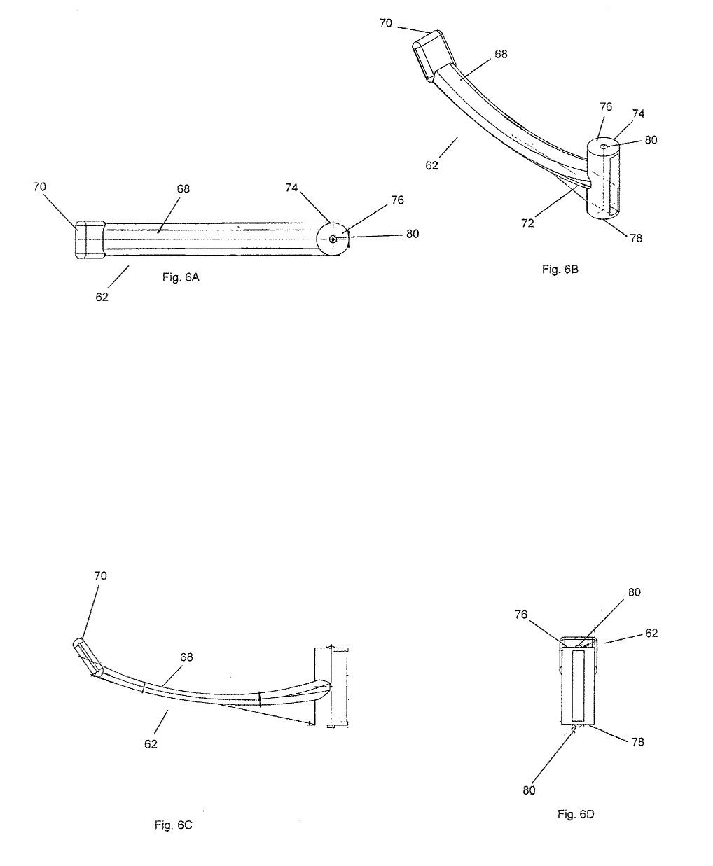

Referring to FIGS. 4A-4G, a latch 36 is pivotably mounted to receptacles defined in pivot posts 34. Specifically, the latch 36 is provided with two pivot pins 38. Each pivot pin 38 is received in a respective receptacle of a respective pivot post 34 to permit the latch 34 to pivot (swing/rotate) about an axis of rotation that is transverse to the longitudinal axis of the second elongated body 22.

The latch 36 includes a latch face 40. The latch face 40 is defined and oriented to abut a catch face 28 in the first elongated body 20 when the latch 36 is in its locked state. The latch 36 is in its locked state when it snaps into window 32 and couples to the bottom edge 42 of window 32. An elongated ridge 44 protruding from the bottom edge of latch 36 permits the snap connection of the latch 36 to the second elongated body 22 to dis-engageably lock the latch 36 to the second elongated body 22. As seen, the latch face 40 is part of a tongue portion 46, which preferably has a shape complementary to the shape of notches 26, which in this embodiment is a quarter of a cylinder.

Latch 36 may further include a small pull 48, which is large enough to receive the tip of a person's index finger, thereby allowing a person to unlock (disengage) the latch 36 from the second elongated body 22 to allow the first elongated body 20 to be extended outwardly to increase the length of the support arm 16, or retracted into the second elongated body 22 to shorten the length of the support arm 16. Together, the latch 36 and the pivot posts 34, and the notches 26 provide a locking mechanism 18 for the preferred embodiment of the present invention.

Referring now to FIGS. 5A-5D, the hook assembly 12 includes a hook support 50 for supporting at least one hook, but preferably a plurality of hooks. The hook support 50 includes a male insert 52 which may be oblong and dimensioned to be inserted into and received by the second elongated body 22 at the bottom end thereof. The male insert 52 includes a plurality of orifices 54, which are aligned with one another and located to receive a screw or the like that is received through orifice 30 in the second elongated body 22 whereby the hook support 50 is integrated with (connected or coupled to) the second elongated body 22. The hook support 50 includes a vertical groove 56 which is parallel to the longitudinal axis of the hook support 50. The hook support 50 includes a plurality (in this embodiment three) of transverse grooves 58 that cross the vertical groove 56. A pivot receptacle 60 is defined and located at the bottom of vertical groove 56. Although not shown, an identical pivot receptacle is defined and located at the top of the vertical groove, in the top wall of support 50, opposite and aligned with the receptacle 60 at the bottom of the vertical groove in the bottom wall of the support 50.

The hook assembly 12 includes at least one hook, preferably three hooks, which are configured to swivel relative to the hook support 50 about an axis of rotation that may be parallel to the longitudinal axis of the hook support 50.

Referring to FIGS. 1A-1F, the hook assembly 12 includes a top hook 62, a middle hook 64, and a bottom hook 66. The top hook 62 and the bottom hook 66 may have the same configuration.

Referring to FIGS. 6A-6D, the top hook 62 includes a hook arm 68, which may be arcuate with a free distal end 70, and a proximal end 72, which is integral with a swivel head 74. Swivel head 74 may be cylindrical with two opposite end faces, a top face 76, and a bottom face 78. Protruding from each face 76, 78 is a nipple 80.

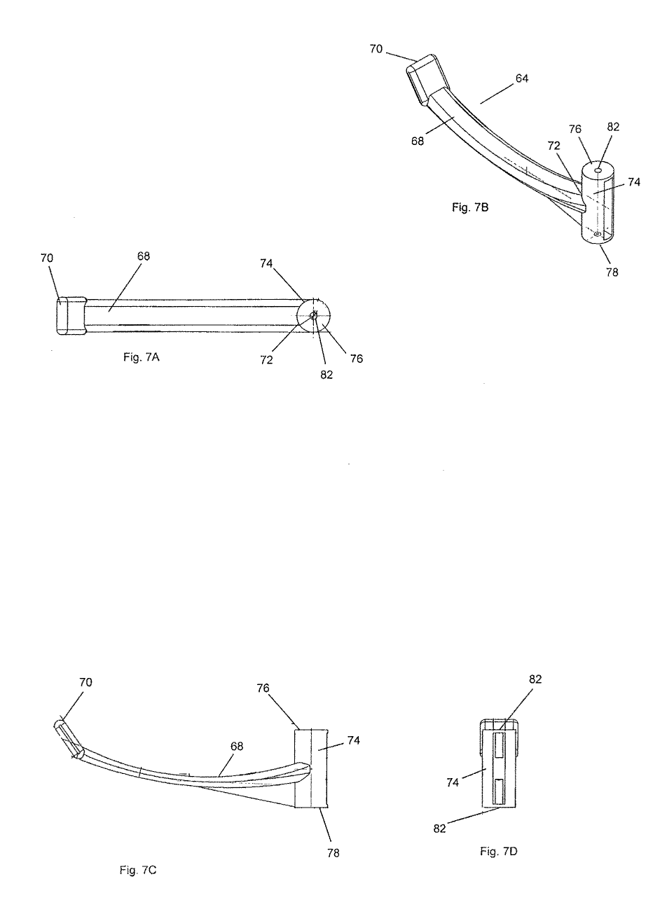

Referring now to FIGS. 7A-7D, in which like numerals identify like features, the middle hook 64 does not have nipples protruding from the top face 76 and the bottom face 78. Instead, receptacles 82 are defined in faces 76, 78 each configured (shaped and dimensioned) for receiving a nipple 80.

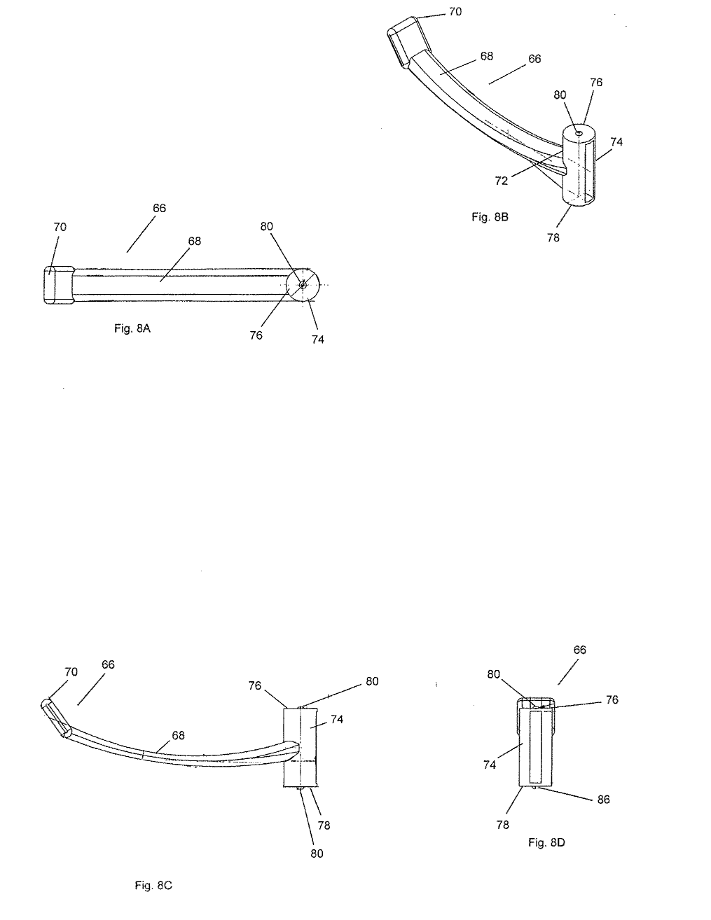

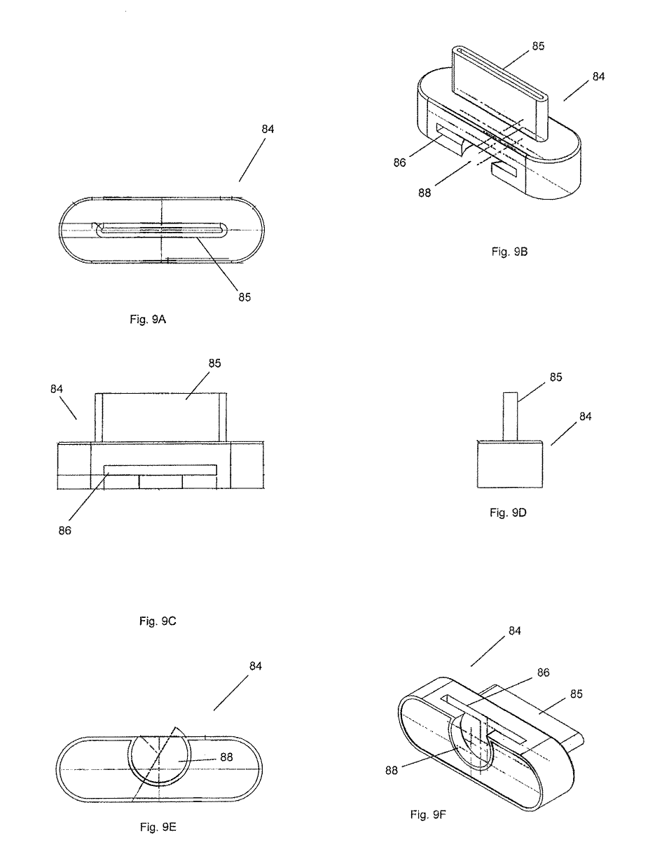

FIGS. 8A-8D, in which like numerals identify like features, illustrate the bottom hook 66.

The hook assembly 12 is assembled as follows. The nipple 80 residing at the bottom hook 66 is received in receptacle 60 in the bottom wall of the hook support 50, and the nipple 80 residing at the top face 76 of the swivel head 74 of the bottom hook 66 is received in the receptacle 82 defined in the bottom face 78 of swivel head 74 of the middle hook 64.

The nipple 80 residing at the bottom face 78 of the top hook 62 is received in the receptacle 82 defined in the top face 76 of the swivel head 74 of the middle hook 64. The nipple 80 residing at the top face 76 of the swivel head 74 of the top hook is received in the receptacle residing at the top of the vertical groove 56 in the top wall of the hook support 50. In this manner, the swivel heads 74 of the three hooks 62, 64, 66 are coupled to one another and coupled to the hook support 50. Nipples 80 are configured to rotate inside the receptacles in which they are received. In addition, the swivel head 74 of the middle hook 64 is configured to rotate relative to the top hook 62 and bottom hook 66. It should be noted that once hooks 62, 64, 66 are assembled their swivel heads 74 are received in the vertical groove 56 and their hook arm 68 can be received inside of transverse grooves 58. Thus, the free ends 70 of the hooks 62, 64, 66 can angularly rotate 180°.

Referring now to FIGS. 9A-9F, the bracket assembly 14 includes a bracket housing with a bottom part 84, which includes an elongated tongue portion 85 projecting from a face thereof and configured (shaped and dimensioned) to be received in the recess 24 at the top end of the first elongated body 20, whereby the bottom part 84 of the bracket housing and the first elongated body 20 are integrated. Integration may be with any suitable method such as gluing or welding.

The bottom part 84 of the bracket housing includes a through passage 86 configured (shaped and dimensioned) to receive a first portion (described below) of a bracket (described below). An arcuate transverse passage 88 is provided in the bottom part 84 of the bracket housing and is connected and in communication with the passage 86.

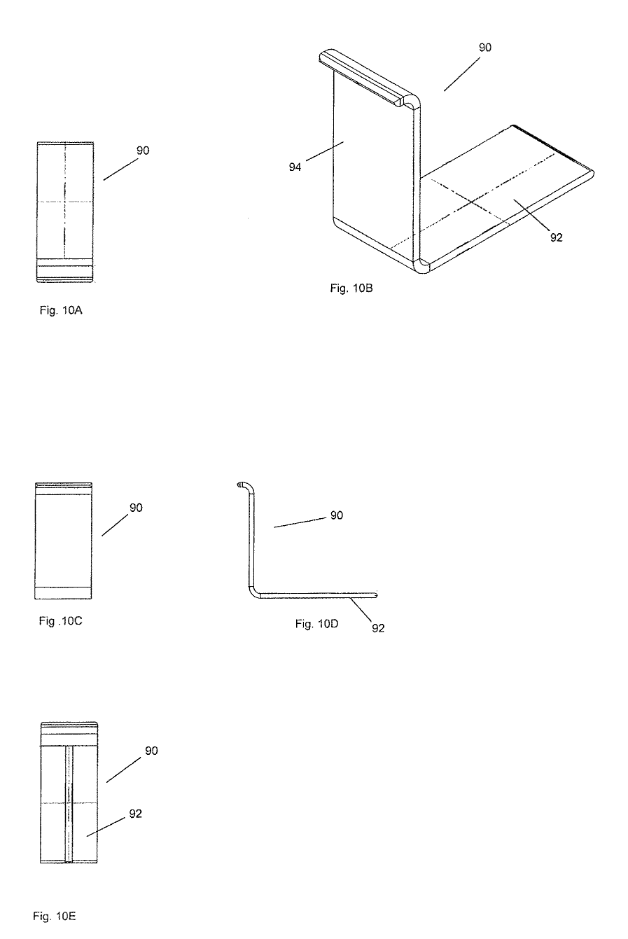

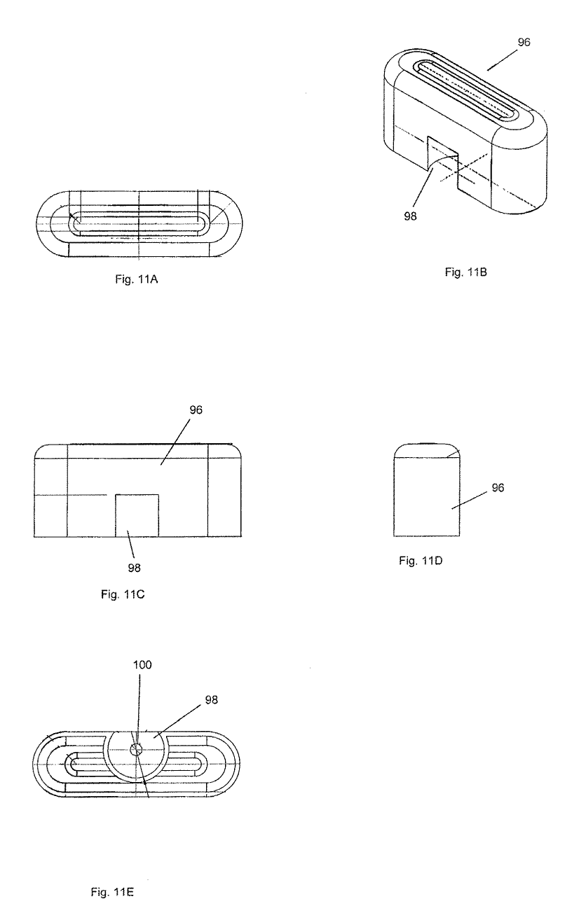

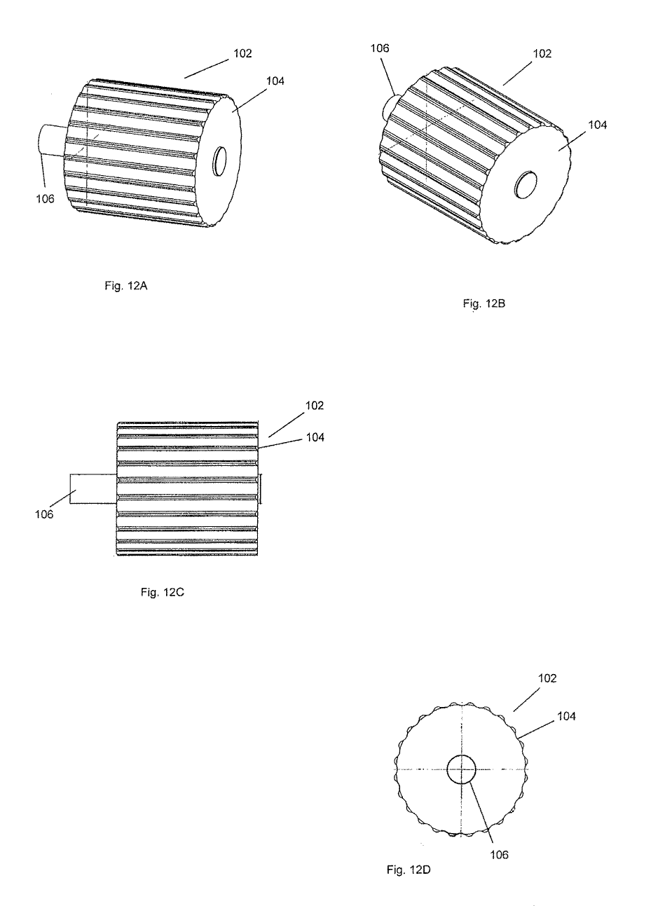

Referring now to FIGS. 10A-10F, the bracket assembly 14 includes a bracket 90. Bracket 90 is preferably an L-shaped body that includes a first portion 92, which is configured (shaped and dimensioned) to be received in the passage 86 of the bottom part 84 of the bracket housing. The bracket 90 includes a second portion 94 which extends in a direction that is transverse to the first portion. The first portion 92 is longer than the passage 86 to permit the adjustment/variation of the space between the second portion 94 and the bottom part 84 of the bracket housing, thereby permitting the bracket to be spaced in correspondence with the dimension of the structure (e.g. thickness of the door) on which the apparatus is supported.

Referring now to FIGS. 11A-11E, the bracket housing of the bracket assembly 14 further includes a top part 96. The top part 96 of the bracket housing would be integrated with the bottom part 84 of the bracket housing. Integration may be realized with any suitable method including, for example, gluing or welding. The top part 96 of the bracket housing includes an arcuate, blind passage 98. A threaded hole 100 is provided at the bottom of the arcuate, blind passage 98 in the body of the top part 96 of the bracket housing.

Referring to FIGS. 12A-12D, a screw 102 having a knob 104 and a threaded portion 106 is configured for assembly with the top part 96 of the bracket housing to enable the securing of the bracket 90 in place. Specifically, the threaded portion 106 is threadably received in threaded hole 100, and the knob 104 is partially received in the arcuate, blind passage 98 and partially received in arcuate passage 88 in the bottom part 84 of the bracket housing. Once the first portion 92 of the bracket 90 is received inside the passage 86, and is in communication with arcuate passage 88, the first portion 92 of bracket 90 can be pressed against the passage wall by unscrewing knob 104 toward the wall of the passage 86 that is opposite to the knob 104.

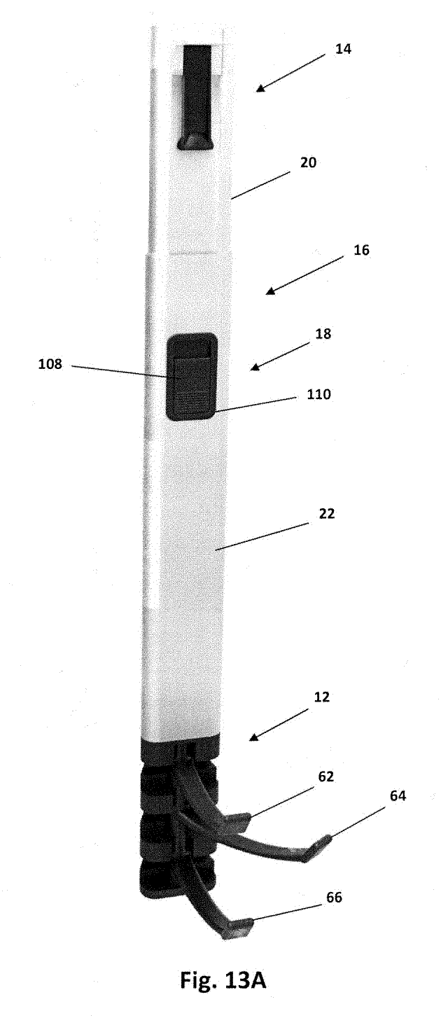

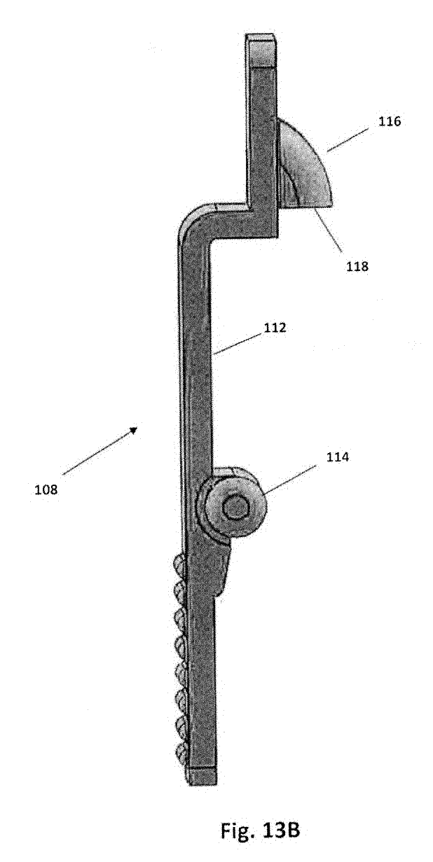

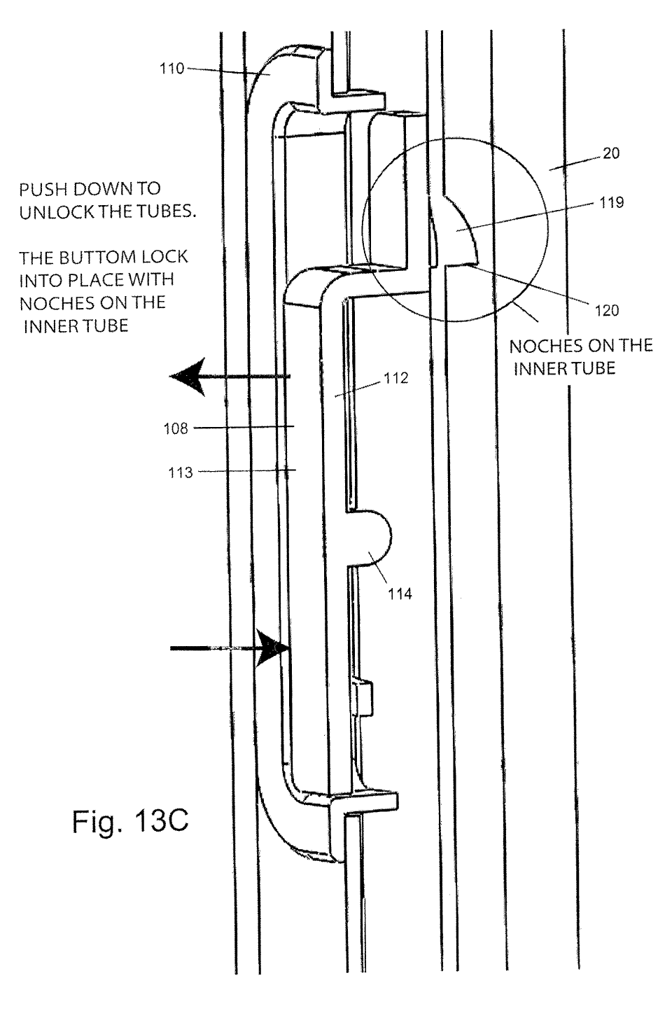

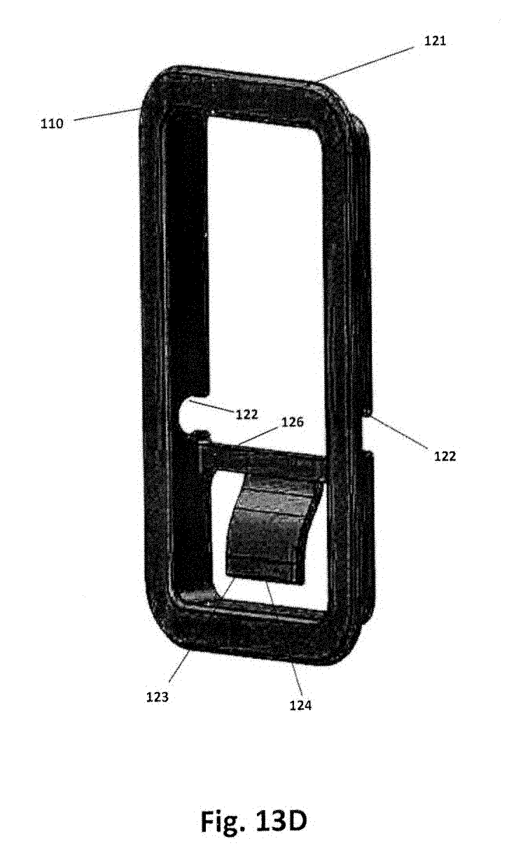

Referring now to FIG. 13A, in which like numerals indicate like features, the locking mechanism 18 includes a push-button 108 mounted in a cradle 110, which is received in an opening in the second elongated body 22.

Referring to FIG. 13B, push button 108 includes a body 112, a transverse shaft 114 integrated with the body 112 and oriented transverse to the longitudinal axis of the body 112, and a tongue portion 116 having a latch face 118 defined and oriented to abut a catch face 120 of a notch 119 defined in a first elongated body 20 as shown in FIG. 13C. The first elongated body 20 will include a plurality of spaced notches 119 each with a catch face 119 as described above with reference to FIGS. 2A-2D, except the notches 119 may have catch faces 120 at the bottom, not at the top as shown in FIGS. 2A-2D.

Referring to FIG. 13D, the cradle 110 may include recesses or cut-aways 122 in a frame portion 121 thereof to receive respective ends of the transverse shaft 114. The respective ends of the transverse shaft 114 may be snap-fitted and coupled to cut-aways 122 to permit push button 108 to swing inside of the cradle's frame 121. The cradle 110 includes a leaf spring 124 mounted inside of the cradle frame 121 below the cut aways 122. For example, leaf spring 124 may be mounted at its base to a transverse elongated support 126, which is integrally connected at each end thereof to the cradle's frame 121, whereby, for example, the free end 123 of the leaf spring 124 can make contact with the back surface of the body 112 of the push button 108.

Referring back to FIG. 13C, when the front face 113 of the body 112 is pressed at a location below the shaft 114 the push button 108 swings about the central axis of the shaft 114, whereby the latch face 118 can be disengaged from the catch face 120 thus unlocking the first and the second elongated bodies 20, 22 permitting their telescopic movement relative to one another. The leaf spring 124, which in this state is deformed and loaded due to the applied force provided by the operator, can then urge the push button to swing in the opposite direction when the external applied force is removed from the front face of the body 112 of the button, thereby permitting the engagement of the latch face 118 and another catch face 120 of another notch 119 (not shown) defined in the first elongated body 20 to lock the first and the second elongated bodies 20, 22 relative to one another.

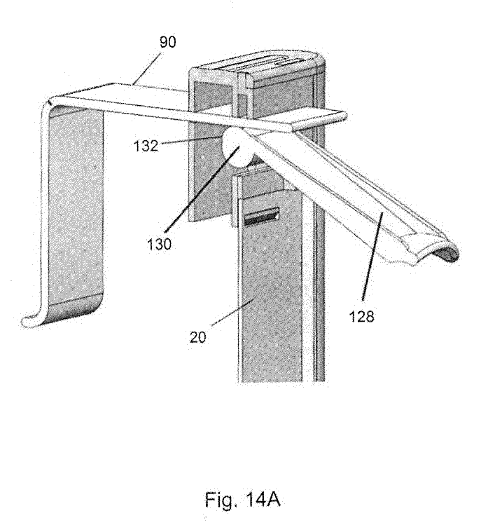

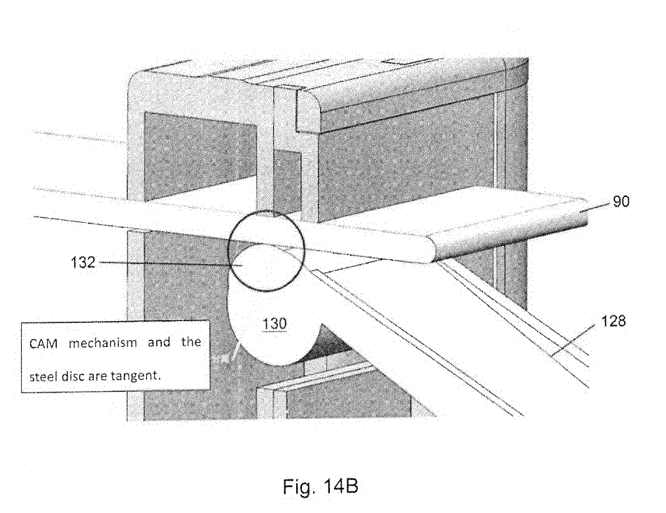

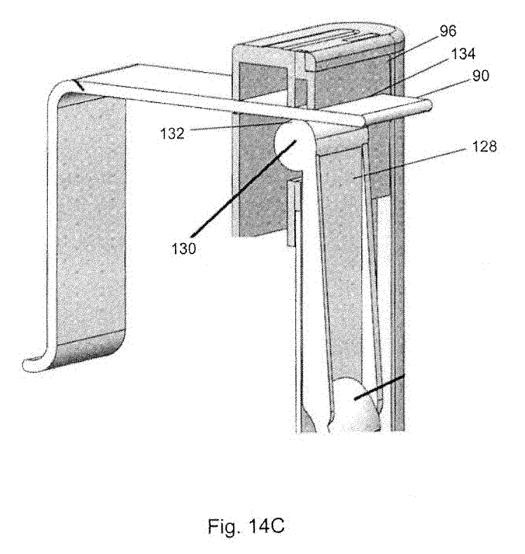

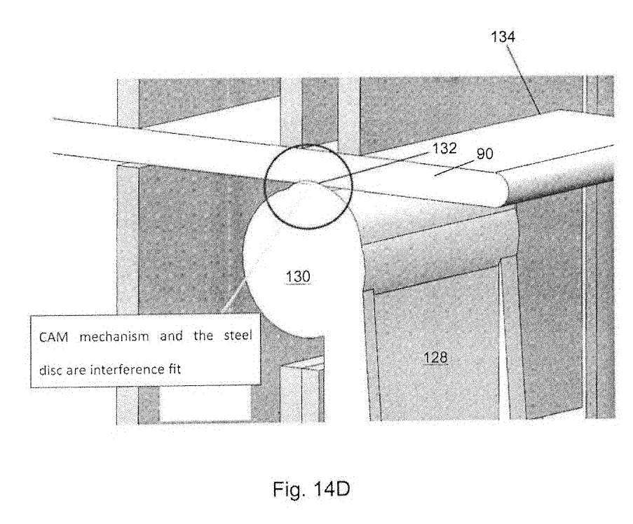

Referring to FIG. 14A, in which like numerals identify like features, the bracket 90 can be fixed in place with a lever (128) operated locking barrel 130. Barrel 130 includes a bulging portion 132 (see FIG. 14B). The barrel 130 is rotatably mounted to, for example, the top part 96, to swing about an axis transverse to the longitudinal axis of the first elongated body 20. The lever 128 can be used to rotate the barrel 130. As seen in FIG. 14C, the barrel 130 is rotated to press the bracket 90 against the opposite wall 134 of a passage defined in the top part 96 to receive the bracket 90 therein, sandwiching the bracket 90 between the bulging portion 132 and the opposite wall 134, thereby fixing the bracket 90 in place. To adjust the position of the bracket 90, the operator can rotate the barrel 130 in the opposite direction thereby moving the bulging portion 132 out of direct contact with the bracket 90 to permit movement of the bracket 90 relative to the top part 96. Thus, the relative position of the bracket 90 can be adjusted using the lever 128 operated barrel 130.

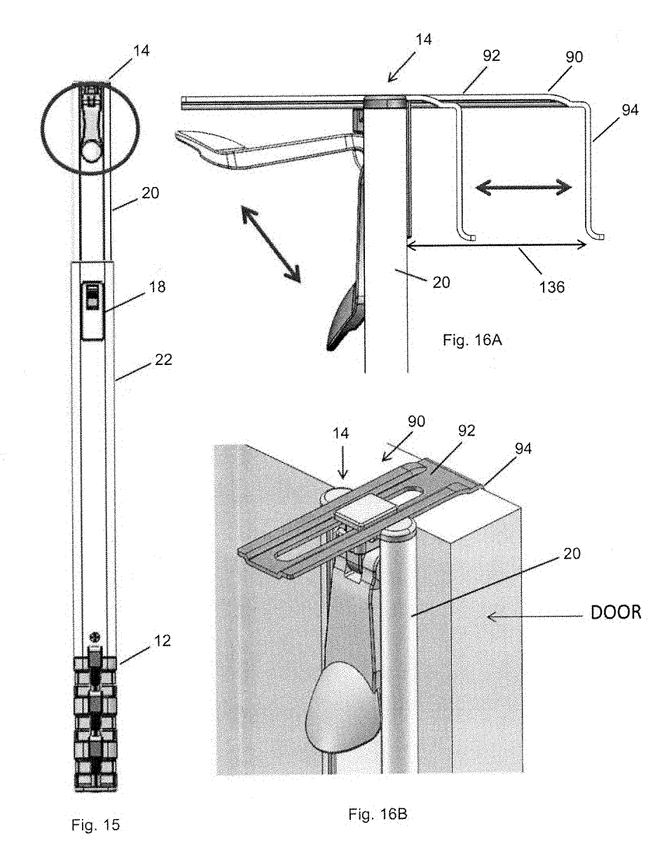

FIG. 15 depicts a front view of an apparatus according to the third embodiment of the present invention, which includes a bracket assembly 14 integrated and connected to an end of a first elongated body 20, a second elongated body 22, which receives the first elongated body 20 therein, a hook assembly 12, which may have reorientable hooks 62, 64, 66 as previously described, and a locking mechanism 18. As in the other embodiments, the first elongated body 20 is telescopically insertable into and telescopically retractable from the second elongated body 22 to allow for length adjustment, and the locking mechanism 18 is provided to engageably and disengageably lock the first elongated body 20 in place selectively as will be further described below.

Referring to FIGS. 16A and 16B, the bracket assembly 14 includes a bracket 90 with a first portion 92 and a second portion 94. Bracket 90 is movable relative to the first elongated portion 20 to define a space 136 between the first elongated portion 20 and the interior surface of second portion 94 that faces the first elongated portion 20 in order to, for example, adjust to the thickness of a door on which the apparatus may be supported as illustrated in FIG. 16B.

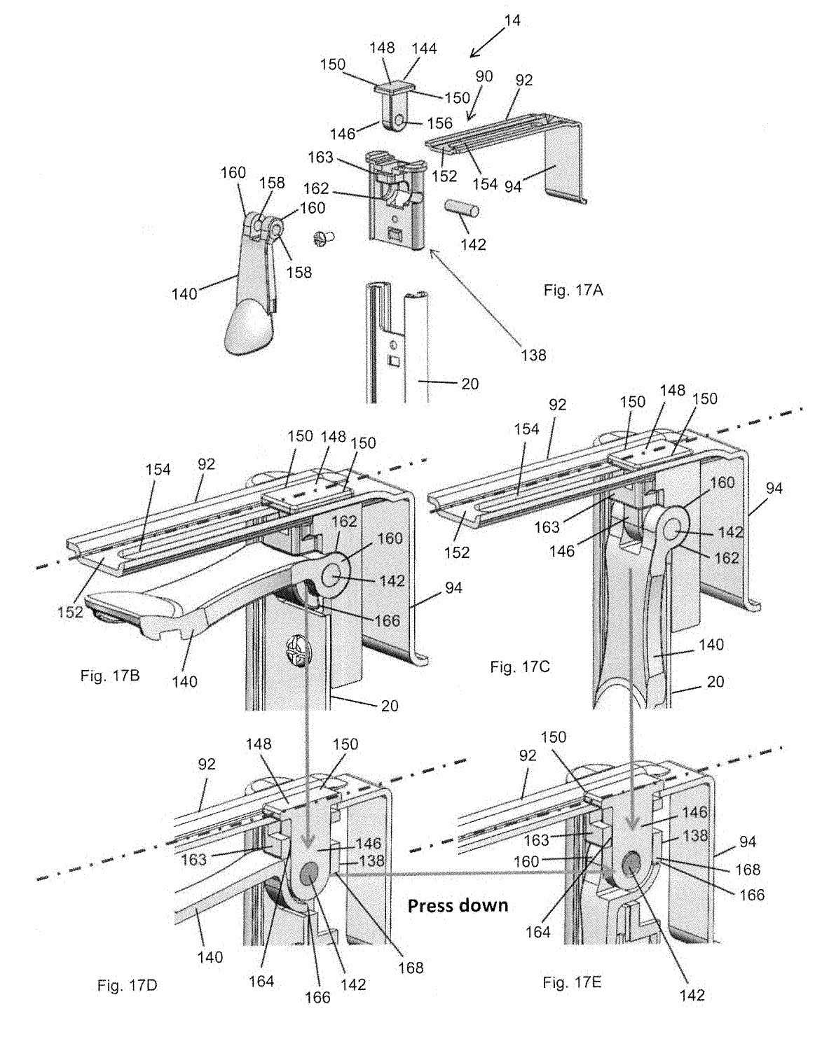

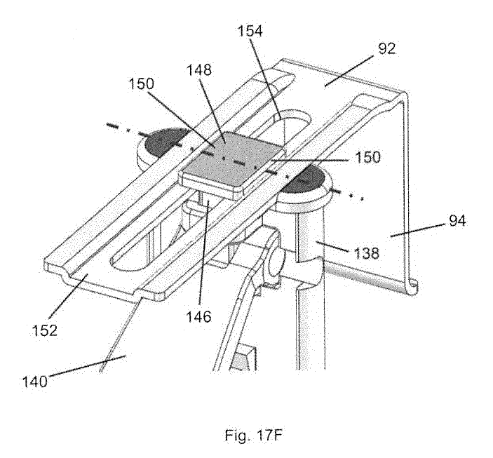

Referring now to FIGS. 17A-17E, the bracket assembly 14 may further include an assembly support 138, lever arm 140, a pivot pin/shaft 142, and a press 144, which includes a stem 146 and a head 148 with sides 150 that flange outwardly. The first portion 92 of the bracket 90 of the third embodiment includes a longitudinal depression 152. A longitudinally extending slot 154 is defined at the bottom of the longitudinal depression 152. The stem 146 has a small enough width to be received inside of the slot 154; however, the head 148 is too wide to pass through the slot 154. Thus, the flanged sides 150 of the head 148 would be intercepted by the bottom of the recess 152 surrounding the longitudinal slot 154. To lock the bracket 90 in place, the head 148 is pulled downwardly toward the assembly support 138 by pulling on the stem 146 to sandwich the bottom portion of the recess 152 surrounding the slot 154 between the flanged sides 150 and the assembly support 138. Specifically, the lever arm 140 is pivotably coupled with the pivot pin 142 to an eyelet 156 defined at the end of the stem 146 that is opposite the head 148. The eyelet 156 registers with eyelets 158 defined in respective bearing elements 160 located at an end of the lever arm 140. To assemble the bracket assembly 14, the stem 146 is passed through the longitudinal slot 154, received between the two opposite bearing elements 160 such that the eyelet 156 registers with eyelets 158 to receive pivot pin 142. The assembly support 138 includes a yoke portion 163 having an opening 164 through which the stem 146 is received. Once received in the opening 164, the stem 146 is restricted from side-to-side movement by the yoke 163, but may move slidably in the longitudinal direction (i.e. toward and away from the first elongated body 20) inside of the yoke 163. A portion of the stem 146 will be below the opening 164 between two, spaced, semi-cylindrical bearing cages 162 defined in the bracket support 138. Each bearing element 160 of the lever arm 140 is semi-cylindrical and received in a respective semi-cylindrical bearing cage 162. The exterior surface of each bearing elements 160 and the interior surface of the bearing cage 162, in which it is received, are complimentary permitting the bearing elements 160 to rotatably slide against the surfaces of the cages 162 when the pivot pin 142 is inserted into eyelets 156, 158 in the registered state. That is, the bearing elements 160 and the bearing cages 162 form a simple bearing arrangement in which semi-cylindrical bearing elements 160 are journaled to rotate inside semi-cylindrical cages 162. Thus, the lever arm 140 will be permitted to swing relative to the stem 146 in the assembled state. The lever arm 140 includes an abutment surface 166 (see FIGS. 17D, 17E) at a location opposite its free end. The abutment surface 166 of the lever arm 140 abuts against an abutment surface 168 on the bracket support 138 when the lever arm 140 is in the locking state. In the locking state, the abutment surface 166 pushes against the abutment surface 168 thereby pulling the stem 146 toward the first elongated portion 20 thus forcing the sides 150 of the head 148 to press against the first portion 92, sandwiching the first portion 92 between the sides 150 of the head 148 and the bracket support 138.

As shown in FIG. 17F, the top end of the bracket support 138 may be recessed to receive the first portion 92, thereby permitting the top exterior surface of first section 92 to be flush with the top end surface of the bracket support 138 and the top end surface of the head 148. In addition, both ends of the slot 154 may be closed. Thus, the stem 146 will prevent the bracket 90 from being pulled away from the bracket support 138.

The bracket support 138 may be partially received inside of the first elongated body 20 and attached to an end of the first elongated body 20 with a screw or the like.

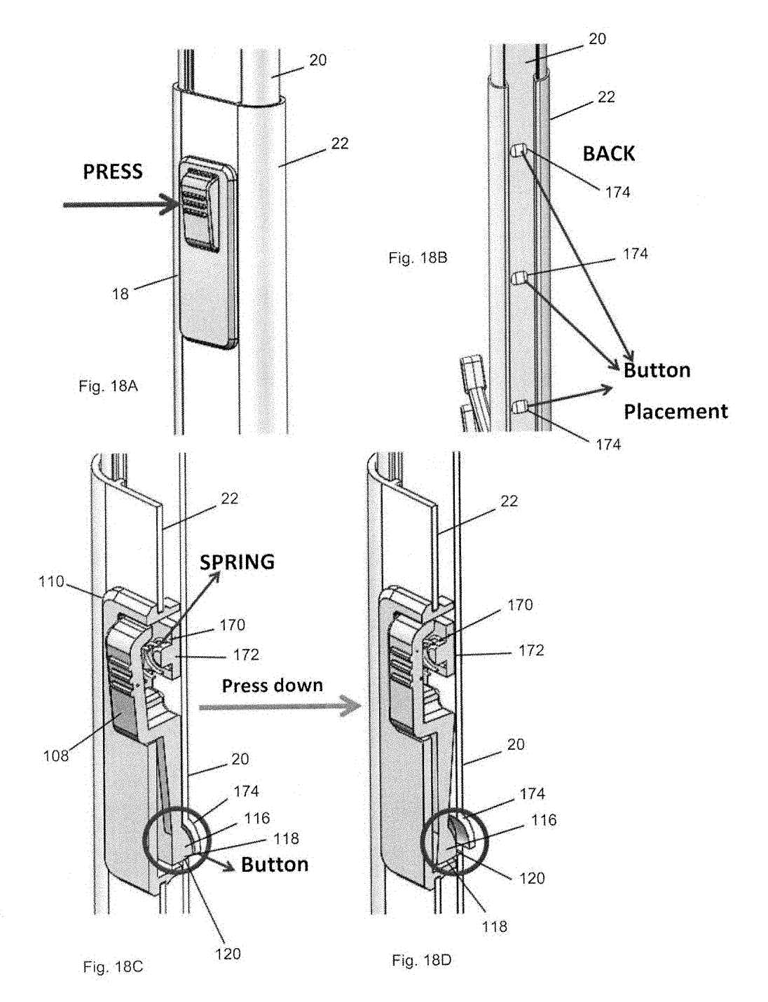

Referring to FIGS. 18A-18D, a locking mechanism 18 in the third embodiment is similar to the locking mechanism 18 in the second embodiment. However, instead of a leaf spring 124 (FIG. 13D), the locking mechanism 18 in the third embodiment uses a coil spring 170 (see FIGS. 18C and 18D). The push button 108, which is rotatably mounted to the frame portion 121 of the cradle 110 in the same manner as described previously, will swing when pushed inwardly relative to the cradle 110 whereby the latch face 118 of the tongue portion 116 will disengage from a catch surface 120 defined in the first elongated body 20. Once the operator stops pushing on the push button 108, the coil spring 170, which is located between the back surface of the push button 108 and a pan portion 172 of the cradle 110, will return the tongue portion 116 to its locking state, whereby the latch face 118 of the tongue portion 116 may abut a catch surface 120 as shown in FIG. 18C and fix the first elongated portion 20 relative to the second elongated portion 22.

The pan portion 172 may be integrated with the frame portion 122 of the cradle 110 at the location of the leaf spring 124 (omitted in this embodiment). In the preferred embodiment the pan portion 172 and the frame portion 121 form a unitary body.

Referring to FIG. 18B, to define catch surfaces 120, bump-outs 174 may be defined in the first elongated body 20. The bump-outs 174 may be bulging in a direction away (projecting outwardly) from the second elongated body 22. The bottommost bump-out, however, may project toward (projects inwardly) the second elongated body 22 to function as a stop that abuts the frame portion 121 of the cradle 110 to prevent the first body portion 20 from being pulled out of the second body portion 22.

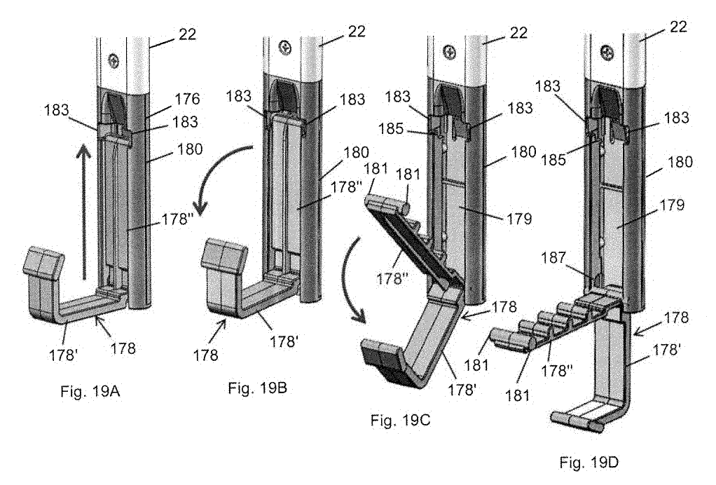

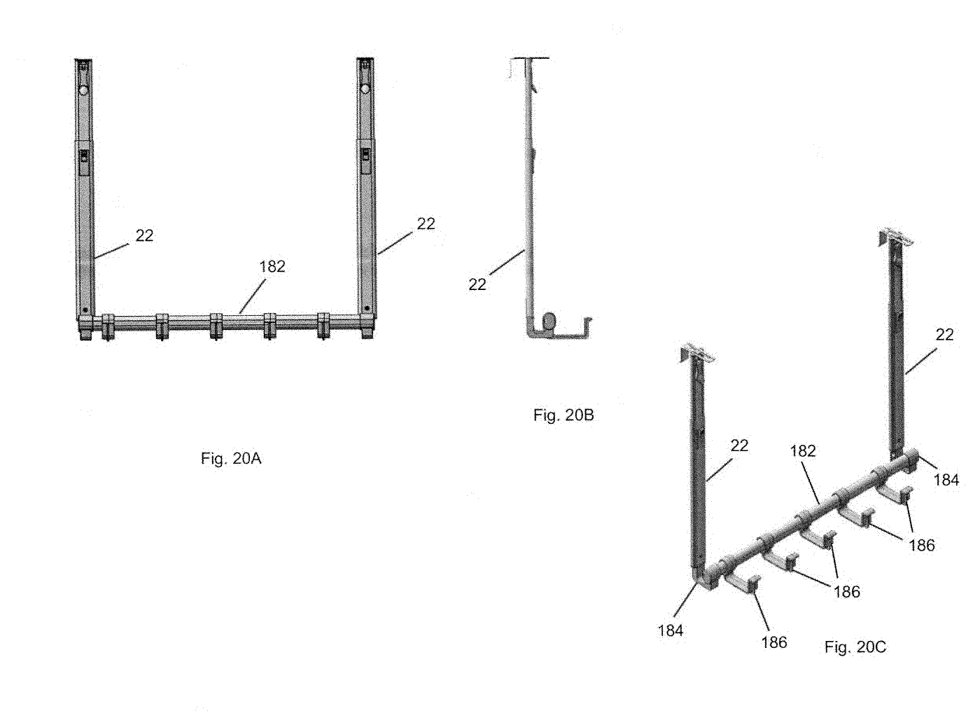

Referring to FIGS. 19A-19D, in any one of the embodiments described above, the hook assembly 12 with reorientable hooks 62, 64, 66, may be replaced with a hook assembly 176, which includes a hook 178 rotatably mounted to a hook support 180. The hook 178 includes a first hook portion 178′ and a second hook portion 178″. In the first state (FIG. 19A), only the first hook portion 178′ is deployed and available for use (meaning it provides support on which something could be hanged) and the second hook portion 178″ is stored in a storage compartment 179 defined in the hook support 180. In the second state (FIG. 19D), the second hook portion 178″ is rotated away from the storage compartment 179 (see FIG. 19C) and deployed as shown in FIG. 19D. In the second state, the first hook portion 178′ and the second hook portion 178″ are available for use in that both portions include at least one section on which something could be hanged.

The second hook portion 178″ is slidably movable inside of the storage compartment. In order to rotate hook 178 from the first state to the second state, the hook 178 is shifted upwardly (see FIG. 19A) until stops 181 residing at the free end of the second hook portion 178″ are aligned with respective gaps 183 defined at the top of the storage compartment 179 (see FIG. 19B). At this stage the hook 178 is free to rotate as shown in FIG. 19C until it reaches the second state shown in FIG. 19D. In the stored state, the stops 183 reside in respective cradles 185 (see FIGS. 19C and 19D), thereby preventing the hook 178 from rotating. It should be noted that hook 178 includes pivot pins (not shown) at a region where the first hook portion 178′ and the second hook portion 178″ are joined. Each pivot pin is received inside of a respective elongated groove 187 (one shown in FIG. 19D), which permits the up or down shifting of the hook 178 while it remains rotatably mounted to the hook support 180.

Referring to FIGS. 20A-20C, instead of a hook assembly, the second elongated body 22 of any one of the embodiments described above may be attached to a respective end of a cross bar 182 with a suitable coupling 184 that couples the cross bar 182 to the bottom end of the second elongated body 22. A plurality of laterally arranged and movable (for example, slidable) hooks 186 may be mounted to the cross-bar 182.

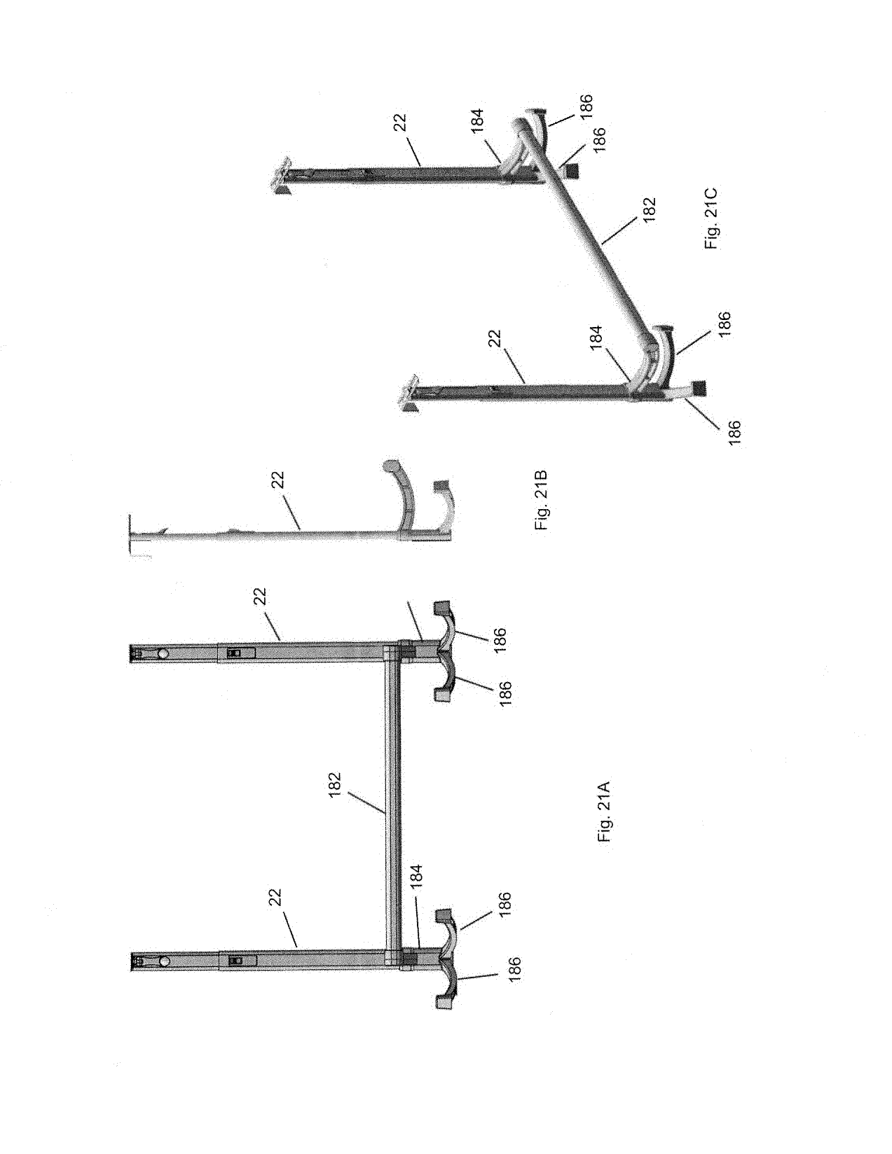

Referring to FIGS. 21A-21C, the coupling 184 may optionally include additional hooks 186.

An apparatus according to the present invention can be made of any suitable material including a suitable plastic or a combination of different materials such as metal parts and plastic parts.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A support apparatus comprising: a bracket section, a hook section supported by the bracket section, and an intermediate section connecting the bracket section to the hook section, at least one of the bracket section and the intermediate section being adjustable.

2. A support apparatus according to claim 1, wherein the hook section includes hooks that can be reoriented relative to one another.

3. A support apparatus according to claim 1, wherein the intermediate section is adjustable telescopically to permit length adjustment.

4. A support apparatus according to claim 1, wherein the bracket section includes a bracket portion that can be displaced relative to the intermediate section to permit the fitting of the bracket section to a support structure.

5. The support apparatus of claim 1, wherein the intermediate section is adjustable to permit length adjustment, and further comprising a lock mechanism to permit selective length adjustment of the intermediate section.

6. The support apparatus of claim 5, wherein the intermediate section comprises a first elongated body telescopically received in and displaceable relative to a second elongated body, and wherein the locking mechanism permits selective locking of the first elongated body to the second elongated body.

7. The support apparatus of claim 6, wherein the locking mechanism includes a button rotatably mounted to a cradle, the button including a portion that engages the second elongated body.

8. The support apparatus of claim 7, wherein the lock mechanism further includes a spring that maintains the portion of the button that engages the second elongated body engaged with the second elongated body.

9. The support apparatus of claim 1, wherein the bracket section comprises a bracket assembly integrated with the intermediate section, and including a bracket that is movable to permit position adjustment of the bracket.

10. The support apparatus of claim 9, wherein the intermediate section is adjustable to permit length adjustment, and further comprising a lock mechanism to permit selective length adjustment of the intermediate section.

11. The support apparatus of claim 10, wherein the intermediate section comprises a first elongated body telescopically received in and displaceable relative to a second elongated body, and wherein the locking mechanism permits selective locking of the first elongated body to the second elongated body.

12. The support apparatus of claim 6, wherein the locking mechanism includes a button rotatably mounted to a cradle, the button including a portion that engages the second elongated body.
